(19) United States
(12) Patent Application Publication
(10) Pub. No.: US 2005/0194402 A1
(43) Pub. Date: Sep. 8, 2005

(54) Compact Electronic Pour Spout Assembly

(75) Inventor: Christopher S. Morrison, Scottsdale, AZ (US)

Correspondence Address: Lowell W. Gresham;Meschkow & Gresham, P.L.C., 5727 North Seventh Street, Suite 409, Phoenix, AZ, 85014, US

(73) Assignee: NUVO HOLDINGS, LLC, Scottsdale, AZ (US)

(21) Appl. No.: 10/906,647

(22) Filed: Feb. 28, 2005

Related U.S. Application Data
(60) Provisional application No. 60/551,191, filed on Mar. 8, 2004.
(60) Provisional application No. 60/650,307, filed on Feb. 3, 2005.

(51) Int. Cl. B67B 7/00; G01F 11/00; B65D 5/66

(52) U.S. Cl. 222/113

(57) ABSTRACT

A compact electronic pour spout assembly (22) includes a pour spout (28) and a shell (30) locked together by a resilient sealing member (42). A neck (64) of the sealing member (42) is inserted into an opening (36) through the shell (30), and pour spout (28) is inserted into the neck (64) to expand the neck (64), locking the three components in place. A small, non-replaceable battery (84) is permanently sealed in the shell (30). Mount detection switches (90) are located on opposing sides of the opening (36) from the battery (84). Light (150) emitted from one side of a printed wiring board (73) is guided through an inner shell (122) and visible in several directions outside of the shell (30).

### RELATED INVENTION

The present invention claims benefit under 35 U.S.C. 119(e) to “Inventory Systems and Methods,” U.S. Provisional Patent Application Ser. No. 60/551,191, filed 8 Mar. 2004, and to “Inventory Systems and Methods,” U.S. Provisional Patent Application Ser. No. 60/650,307, filed 3 Feb. 2005, both of which are incorporated by reference herein.

The present invention is related to “Asset Tag with Event Detection Capabilities,” Ser. No. 10/795,720, filed 8 Mar. 2004, having at least one inventor in common herewith, which is incorporated by reference herein.

### TECHNICAL FIELD OF THE INVENTION

The present invention relates generally to pour spouts. More specifically, the present invention relates to pour spouts which are integrated with electronics to form electronic pour spout assemblies.

### BACKGROUND OF THE INVENTION

Pour spouts control the dispensation of liquids from bottles. In a typical application, a pour spout is placed in the opening of a bottle, in lieu of a bottle cap, lid, cork, or stopper. When the bottle is tilted toward an inverted position, liquid contained in the bottle flows out from the pour spout. Conventional pour spouts aim the stream of liquid exiting the bottle in a direction that tends to be more convenient for pouring. And, they allow air into the bottle as the liquid exits so that pressure inside the bottle, and consequently liquid flow rate, remain more consistent. Moreover, pour spouts tend to reduce the rate of liquid flow exiting the bottle to a more manageable level for pouring precise amounts.

Conventional pour spouts come in a variety of designs. Most include a stopper or cork to seal against the inside of the neck of a bottle, a pour tube through which the beverage exits the bottle, and a vent tube through which air enters the bottle as the beverage exits. More modern versions of conventional pour spouts use a somewhat stiff, molded, plastic cork having annular rings that seal against the inside of the neck of the bottle. One advantage of the use of a somewhat stiff plastic material is that the molded cork may be easily removed from the bottle when compared to a more supple plastic material. But this conventional cork does not seal as well as a more supple material, and the somewhat stiff material tends to deform and break after only a moderate number of insertions and removals. When a cork deforms, it may fail provide an adequate seal, particularly when moved to a bottle with a larger diameter neck.

Establishments which pour and/or sell one-at-a-time drinks, such as alcoholic beverages, for on-site consumption, hereinafter called bars, tend to maintain an inventory of a wide variety of bottles of liquids from which drinks are poured. And, bars may from time to time get very busy dispensing drinks for patrons. By using pour spouts on their bottles, or at least a portion of them, even in busy times more consistent drinks can be poured, fewer spills occur, and when bottle spills occur they tend to waste fewer drinks.

Another desirable feature resulting from the use of pour spouts is that a greater opportunity is provided for a beverage server, such as a bartender, to exhibit flair. Flair refers to the individualistic, stylish, and/or showmanship actions of a bartender while dispensing a drink. Examples include pouring with one hand, flipping bottles and/or glasses, making exaggerated gestures, dancing, and the like. Since pour spouts reduce and control the flow rate of the liquid exiting the bottle, the bartender has more opportunity to engage in flair without unduly risking a spill or pouring an improper amount.

And, bartender flair can be a strong component of an establishment's marketing goals. The reason many people go to bars is for the experience and ambiance. Patrons like to think they are getting a good pour for their money, and the more freedom and control a bartender has while dispensing drinks the better. Free-pouring with the aid of pour spouts may be a necessity for certain bar marketing concepts including, for example, neighborhood bars and upscale bars. Generally speaking, bars are very competitive businesses, and customers are more likely to drink at a bar where they can enjoy a better ambiance, better service, and a better overall experience.

To those who manage bars and similar establishments, the dispensed drinks represent inventory. And, in order to efficiently manage the bar, it is desirable to capture information regarding the identity and amount of inventory involved in each transaction. This is a challenging task. Unlike establishments that sell packaged or labeled goods which bear barcodes or inventory-identifying insignia that may be automatically captured during a transaction, bars tend to sell bulk products which do not bear barcodes or inventory-identifying insignia. So, in order to meet this challenge, systems have been developed to electronically monitor and capture inventory usage data for drinks dispensed from bottles.

Conventional systems which attempt to capture data concerning inventory usage for liquids dispensed from bottles have integrated electronics with pour spouts to form electronic pour spout assemblies. Generally, an electronic pour spout assembly is a battery-powered device that detects an event, such as the tilting of the bottle, and reports this event to a monitoring station. By detecting the tilting of a bottle and timing the duration of the tilt, knowledge concerning the amount of liquid dispensed is gained. And, when unique electronic IDs' of electronic pour spout assemblies are associated with different bottles containing different brands or types of liquids, then knowledge concerning the identities of the liquids dispensed is also gained. Unfortunately, the conventional electronic pour spout assemblies have so invasively impeded a bartender's ability to engage in bartender flair, have so deteriorated the ambiance of the bar, and have done such a poor job in providing usable data that they have been unacceptable for many, if not most, bar marketing concepts.

While conventional electronic pour spout assemblies suffer many failings, one of the most prominent failing is the undesirably large size and ungainly appearance of the conventional assemblies. When the electronic pour spout assembly is too large, it is readily noticed by bar patrons and detracts from ambiance. Patrons tend to believe, rightly or wrongly, a prominent gadget attached to the top of a bottle might mean that the bartender does not have the freedom to deal with them on an individual, one-on-one basis, that they are being cheated, or that their drink is being contaminated in one way or another. This belief, rightly or wrongly, is amplified when the device has the appearance of a plastic, molded device, which may suggest to some patrons, rightly or wrongly, that it is an inexpensive or low-quality device of the type that would appeal to the management of an establishment with an excessive zeal for profits over customer service. These types of beliefs are extremely damaging to many bar marketing concepts. And, the larger the electronic pour spout assembly, the more it impedes the bartender's freedom and control in engaging in flair and the more likely spills become.

Conventional electronic pour spout assemblies are undesirably large for a variety of factors. For example, they tend to use techniques for attaching or integrating a bottle sealer to a pour spout and an electronics housing that extends a great distance beyond the neck of a bottle in all directions in order to achieve a sufficiently strong structure to withstand daily use. An electronic pour spout assembly that extends a great distance in all directions away from a bottle neck is far too prominent relative to the bottle itself for many bar marketing concepts.

Conventional electronic pour spout assemblies tend to use electrical power inefficiently, necessitating the use of a large battery and/or special accessible compartments for holding batteries which must be replaced often. The use of large batteries and/or special accessible battery compartments also leads to undesirably large and prominent electronic pour spout assemblies.

One conventional electronic pour spout assembly includes a switch activated by the neck of the bottle in which the assembly may be installed to signify that the assembly is mounted on the bottle. But such a switch is implemented in a manner that provides an unreliable indication and in a manner that extends the size of the electronics housing to accommodate the switch.

One conventional electronic pour spout assembly includes a light which flashes to provide a bartender with feedback. But the light is implemented in a way that allows it to be seen only from above the bottle when the bottle is upright. Any feedback provided to a bartender while in the act of pouring is lost because the light cannot be viewed from the other side of the assembly.

### SUMMARY OF THE INVENTION

Accordingly, it is an advantage of the present invention that an improved compact electronic pour spout assembly is provided.

Another advantage is that a compact electronic pour spout assembly provides a space-saving way to attach a pour spout, sealer and electronics housing to one another.

Another advantage is that a compact electronic pour spout assembly is provided in which the pour spout is easily separated from the sealer and electronics housing so that the pour spout may be washed.

Another advantage is that a compact electronic pour spout assembly provides a space-saving and reliable way to signify that the assembly is installed in a container.

Another advantage is that a compact electronic pour spout assembly is provided with visible user feedback observable on opposing sides of the assembly without increasing the size of the assembly.

Another advantage is that a compact electronic pour spout assembly is provided which includes switching functions and is sealed against the environment without increasing the size of the assembly.

Another advantage is that a compact electronic pour spout assembly is provided which is compatible with the use of a somewhat supple cork.

A portion of these and/or other advantages are realized in one form by a compact electronic pour spout assembly that includes a pour spout, a hollow, resilient, sealing member, and a rigid shell. The pour spout has a blocking member and a rigid pour tube, and the pour tube has an inlet end and an outlet end. The pour tube is attached to the blocking member between its inlet and outlet ends. The sealing member has a neck with an outer wall and an inner wall. The inner wall is configured to accommodate the pour tube. The shell houses an electronic circuit. And, the shell has an opening shaped to conform to the outer wall of the neck of the sealing member. The shell, sealing member, and pour spout are locked to one another by resilient pressing of the sealing member against the rigid pour tube and the rigid shell.

At least a portion of the above and/or other advantages are realized in another form by an improved compact electronic pour spout assembly that includes a shell, an electronic circuit, a pour spout, a sealing member, and a plunger. The shell has an opening surrounding an opening center. The electronic circuit is positioned within the shell and has a printed wiring board surrounding at least a portion of the shell opening. The electronic circuit also has a battery with a center point spaced away from the opening center in a battery direction. The pour spout extends away from a first side of the shell at the shell opening. The sealing member extends away from a second side of the shell at the shell opening, where the second side opposes the first side. The plunger extends away from the second side of the shell, adjacent to the resilient sealing member, adjacent to the shell opening, adjacent to the printed wiring board, and aligned in a direction other than the battery direction and a direction opposite to the battery direction away from the opening center.

At least a portion of the above and/or other advantages are realized in yet another form by an improved compact electronic pour spout assembly which includes a shell, an electronic circuit, a pour spout, and a sealing member. The shell has a shell opening. The electronic circuit is positioned within the shell and is configured to emit a light. The pour spout extends away from a first side of the shell at the shell opening. The sealing member extends away from a second side of the shell at the shell opening, where the second side opposes the first side. The light is visible from outside the first and second sides of the shell.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a side view of an exemplary container in the form of a bottle with an electronic pour spout assembly configured in accordance with the teaching of the present invention installed in an opening of the container;

FIG. 2 shows an assembled side view of the electronic pour spout assembly depicted in FIG. 1;

FIG. 3 shows an exploded side view of the electronic pour spout assembly depicted in FIGS. 1-2;

FIG. 4 shows a side view of a suitable hollow, resilient, sealing member for use in the electronic pour spout assembly of FIGS. 1-3;

FIG. 5 shows a side-by-side view of a top portion of a bottom outer shell section with the sealing member of FIG. 4 therein beside a bottom portion of a top outer shell section with a pour spout therein;

FIG. 6 shows a cross-sectional view of the shell, sealing member, and pour spout;

FIG. 7 shows a top view of the bottom outer shell section at one stage in the manufacturing of the electronic pour spout assembly of FIGS. 1-3;

FIG. 8 shows a block diagram of an electronic circuit housed within the outer shell of the electronic pour spout assembly of FIGS. 1-3;

FIG. 9 shows a bottom view of a printed wiring board with which the electronic circuit of FIG. 8 may be formed;

FIG. 10 shows a top view of the printed wiring board with which the electronic circuit of FIG. 8 may be formed;

FIG. 11 shows a perspective side view of top and bottom inner shell sections which may reside in the outer shell of the electronic pour spout assembly of FIGS. 1-3;

FIG. 12 shows a cross-sectional side view of a mount detection switch that may be formed using the printed wiring board of FIGS. 10-11; and

FIG. 13 shows a perspective view of the electronic pour spout assembly of FIGS. 1-3 which also depicts a tamper shield installed thereon.

### DETAILED DESCRIPTION OF THE PREFERRED EMBODIMENTS

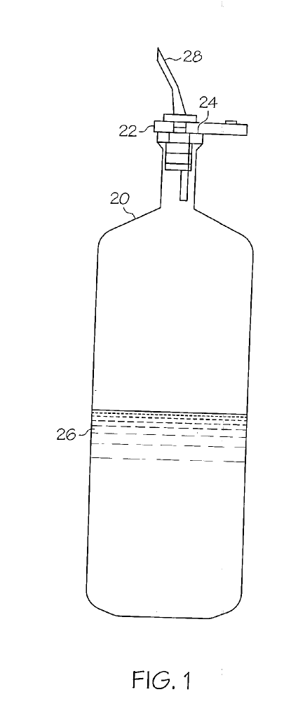

FIG. 1 shows a side view of an exemplary container 20 in the form of a bottle, with a compact electronic pour spout assembly 22 configured in accordance with the teaching of the present invention installed in an opening 24 of container 20. FIG. 1 depicts container 20 in an upright orientation. For the purposes of this description, relative positional terms such as top/bottom, upper/lower, above/below, over/under, upward/downward, left/right, and the like are used herein with respect to a typical application where assembly 22 is installed in a container in the upright orientation, as depicted in FIG. 1, and are not intended to limit the scope of the present invention in any way. But those skilled in the art will appreciate that assembly 22 is to be used in a variety of orientations.

For example, as container 20 is tilted away from its upright orientation toward an inverted orientation, a product 26, in the form of a substance which flows, including a liquid, beverage, and/or drink, is dispensed and exits electronic pour spout assembly 22 through a pour spout 28 thereof. In the preferred embodiment, assembly 22 includes electronics which detect the tilting event, which time the duration of the tilting event, and which report the tilting event, along with its duration and an identifying number associated with the assembly 22, back to a monitoring station (not shown) for further processing by an inventory management system, financial transaction recording system, accounting system, and/or the like.

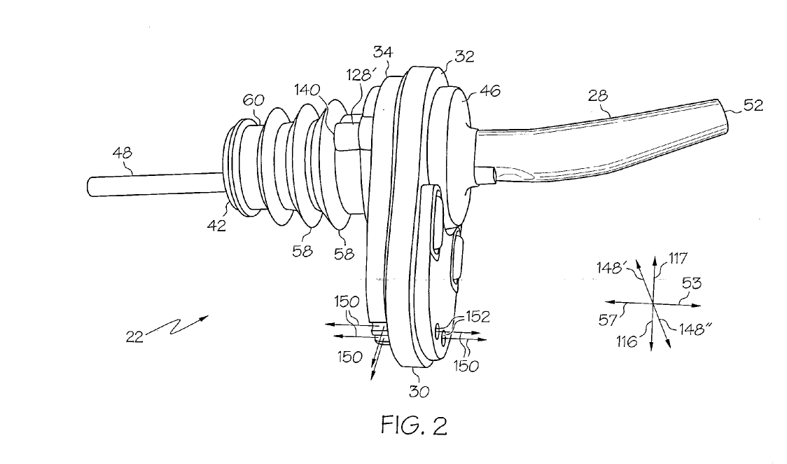

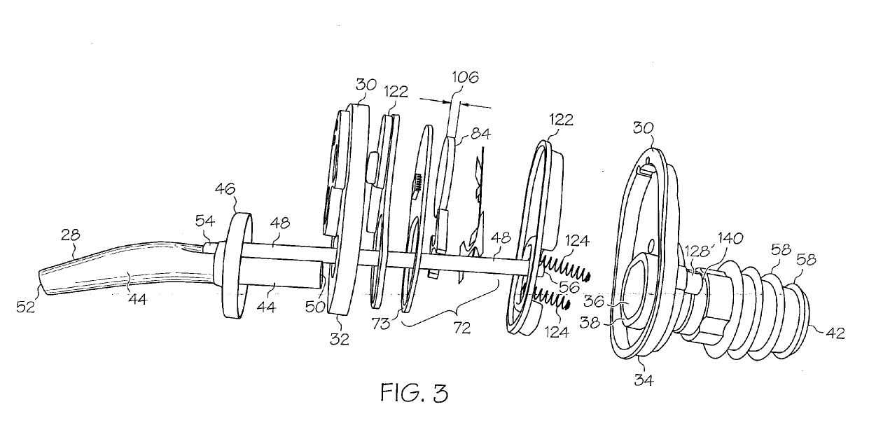

FIG. 2 shows an assembled side view, and FIG. 3 shows an exploded side view, of a compact electronic pour spout assembly 22 configured in accordance with the teaching of the present invention. Referring to FIGS. 2 and 3, assembly 22 includes a rigid outer shell 30 made from a top section 32 and a bottom section 34. Desirably, top and bottom sections 32 and 34 are each molded from a hard plastic, such as ABS, and exhibit a dark, opaque color for aesthetic reasons to minimize the perceived size of assembly 22. Top and bottom sections 32 and 34 are permanently attached to one another, such as by sonic welding or by the use of a suitable adhesive. The word permanently is used in this description to mean permanently within the normal course of operation. In other words, no fastening or opening mechanisms are provided in the preferred embodiment for the separation of top section 32 from bottom section 34 of an assembled shell 30, but such separation may nevertheless be effected by cutting, breaking, and the like. In other words, in the preferred embodiment no user-serviceable components reside within shell 30.

Shell 30 includes an opening 36 which extends from top-to-bottom and is surrounded by a shell-opening wall 38 extending between the top and bottom surfaces of shell 30. Accordingly, respective portions of wall 38 and opening 36 reside in each of top and bottom sections 32 and 34.

Both pour spout 28 and a hollow, resilient, sealing member 42, which may also be called a cork, reside within opening 36 and operate to lock shell 30, pour spout 28, and sealing member 42 to one another. Pour spout 28 is configured in this embodiment as a free-pour, pour spout, but this is not a requirement of the present invention. Other applications may alternatively use a metered pour spout.

Pour spout 28 is itself an assembly of a rigid pour tube 44, a rigid, annular stopping member 46, and a vent tube 48. In the preferred embodiment, pour tube 44, stopping member 46, and vent tube 48 are each formed from metal for rigidity, with stainless steel being a preferred material for its ability to easily maintain cleanliness, but this is not a requirement of the present invention. In addition, the use of metal in general and stainless steel in particular for pour spout 28 is desirable because advantageous amounts of strength and rigidity are provided using a relative thin wall, and the use of thin walls leads to a smaller electronic pour spout assembly 22 than would result from the use of a material, such as a molded plastic, having thicker walls.

Pour tube 44 passes through an opening in stopping member 46 and extends from an inlet end 50 to an outlet end 52. From opening 36, outlet end 52 extends roughly upward, or in a tube-outlet direction 53. Pour tube 44 attaches to stopping member 46 at a position intermediate inlet and outlet ends 50 and 52, but closer to inlet end 50. Vent tube 48 has a smaller diameter than pour tube 44 and is positioned adjacent to pour tube 44 as vent tube 48 extends from an air-inlet end 54 located slightly above stopping member 46, through stopping member 46 to an air-outlet end 56 located below both stopping member 46 and inlet end 50 of pour tube 44. When assembled, stopping member 46 abuts an upper surface of shell 30 and blocks further downward movement of pour spout 28. From opening 36, air-outlet end 56 extends roughly downward, or in a tube-inlet direction 57, which opposes tube-outlet direction 53.

Those skilled in the art will appreciate that the term “diameter” used herein does not imply that the associated feature must be circular or spherical in shape. Rather, “diameter” as used herein refers to a line, whether or not resulting from any physical structure of the associated feature, passing from one side through the center to another side, wherein the associated feature may exhibit any shape.

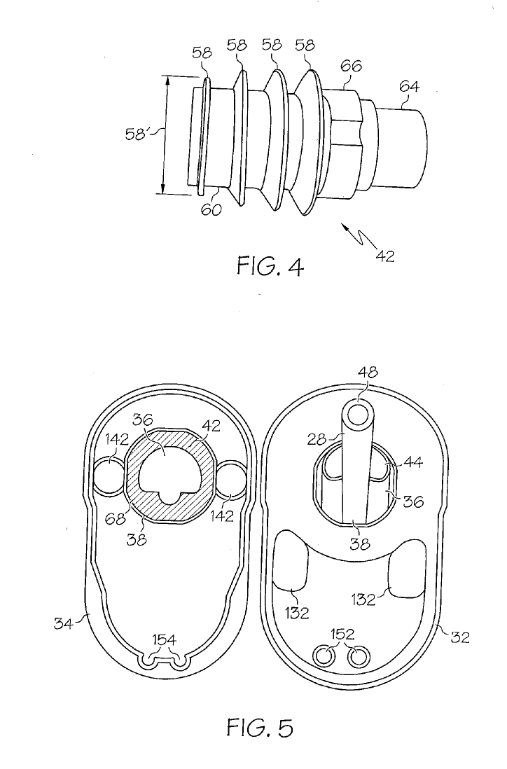

FIG. 4 shows a side view of a suitable sealing member 42 for use in connection with the electronic pour spout assembly 22 depicted in FIGS. 1-3. Referring to FIGS. 1-4, sealing member 42 is molded from an elastomeric material, preferably one which will be substantially inert to product 26, its flavors, and its odors. In the preferred embodiment, sealing member 42 is molded from a material that is somewhat supple and is softer than the materials from which conventional pour spout corks have been molded. Electronic pour spout assembly 22 can still be removed from a bottle with ease due to the transverse projection of shell 30 away from the bottle 20 on which it may be installed. Thus, shell 30 provides leverage which is useful in prying sealing member 42 out of opening 24. And, the use of a somewhat supple material for sealing member 42 provides a good and robust seal against the neck of bottle 20.

Sealing member 42 has a plurality (four shown) of flanges or annular sealing fins 58 extending radially outward from a narrower body 60. Sealing fins 58 get progressively larger in diameter extending from a smallest-diameter 58′ of a smallest sealing fin 58 located closest to the bottom of sealing member 42 to a largest sealing fin 58 located closest to the top of sealing member 42. Body 60 is significantly smaller in outer diameter than the inside diameter of opening 24 of the neck of a typical beverage-holding, bottle-type of container 20 (e.g., 2.2 cm-2.5 cm), but sealing fins 58, and particularly the largest one of sealing fins 58, are larger in diameter than opening 24.

A neck 64 of sealing member 42 is desirably no larger in diameter than the diameter of body 60, and extends upward from a shoulder 66 of sealing member 42 for a distance substantially equal the height, from bottom-to-top, of shell 30. Accordingly, a circumference of neck 64 surrounds a smaller cross sectional area than any of sealing fins 58. Sealing member 42 is desirably inserted into an assembled shell 30 from the bottom side of shell 30, and when so inserted, shoulder 66 abuts the bottom of bottom outer shell 34, and the top of neck 64 is substantially flush with the top of top outer shell 32.

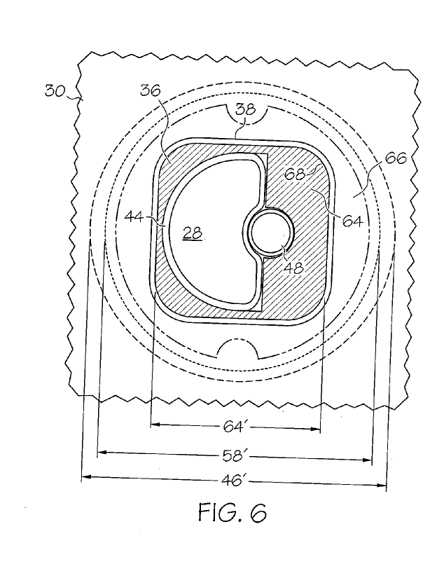

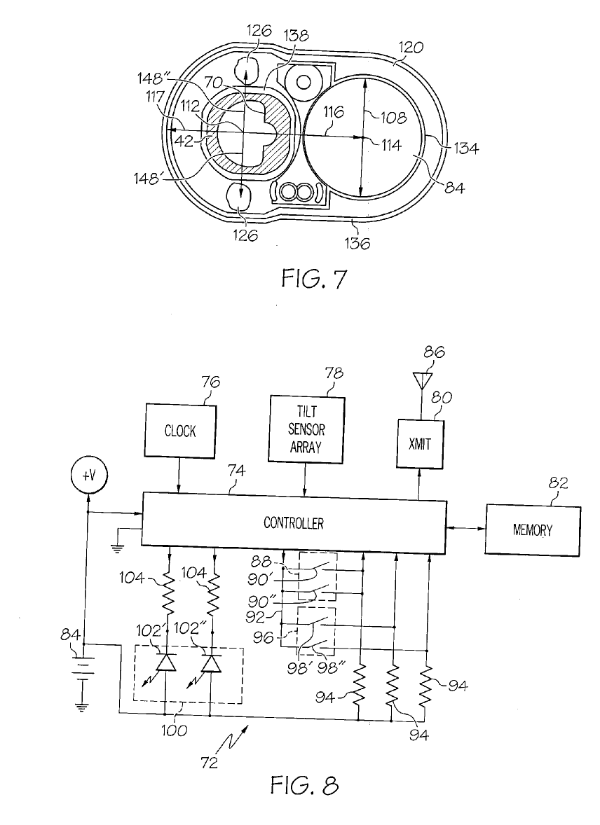

FIG. 5 shows a side-by-side view of a top surface of bottom outer shell section 34 with sealing member 42 therein beside a bottom surface of top outer shell section 32 with pour spout 28 therein. FIG. 6 shows a cross-sectional view of shell 30, pour spout 28, and sealing member 42. FIG. 7 shows a top view of bottom outer shell section 34 at one stage in the manufacturing of the electronic pour spout assembly 22. FIGS. 5-7 together illustrate how shell 30, pour spout 28, and sealing member 42 are locked together.

In the preferred embodiment, neck 64 has an outer wall 68 that exhibits a nonround cross-sectional shape, and shell opening 36 exhibits substantially the same nonround cross-sectional shape. Accordingly, the cross-sectional shape of opening 36 conforms to the cross-sectional shape of neck 64, and neck 64 tightly fits within opening 36. The use of nonround shapes, shown as being generally square but with rounded corners in FIGS. 5-7, for neck 64 and opening 36 prevents shell 30 from rotating relative to sealing member 42. Neck 64 of sealing member 42 is inserted into opening 36 until shoulder 66 abuts a bottom surface of shell 30. Shoulder 66 has a different cross-sectional shape than opening 36, and is larger in the preferred embodiment, so shoulder 66 prevents further upward movement of sealing member 42 into shell 30.

Neck 64 has an inner wall 70 that exhibits a nonround cross-sectional shape, and pour spout 28 exhibits a similar nonround cross-sectional shape. In the preferred embodiment, pour tube 44 proximate and below stopping member 46 where shell 30, pour spout 28, and sealing member 42 lock together, has a somewhat circular shape but is flattened on one side, and vent tube 48 is positioned adjacent to the flattened side of pour tube 44. A combined mushroom-shaped cross-section results, with pour tube 44 being shaped to form the mushroom pielus and vent tube 48 forming the mushroom stem. Inner wall 70 of neck 64 conforms to this mushroom shape. The use of nonround shapes prevents pour spout 28 from rotating relative to sealing member 42.

Moreover, inner wall 70 of neck 64 is dimensioned slightly smaller than pour spout 28 so that pour spout 28 causes neck 64 to expand as pour spout 28 is inserted into the opening of the hollow interior of sealing member 42 when sealing member 42 has been inserted into shell opening 36. This expansion of neck 64 locks sealing member 42 to the more rigid pour spout 28 and the more rigid shell 30 within opening 36 by resilient pressing of sealing member 42 against both shell-opening wall 38 and pour spout 28. And, the use of nonround shapes prevents shell 30 from rotating relative to pour spout 28.

The above-described attachment technique of shell 30, pour spout 28, and sealing member 42 promotes the compactness of assembly 22. Opening 36 in shell 30 need accommodate only neck 64 from sealing member 42, and neck 64 has a relatively small diameter 64′ relative to other features of assembly 22. In particular, opening 36 is smaller in diameter than either of smallest diameter 58′ or a diameter 46′ of annular stopping member 46. In the preferred embodiment, shell 30 extends only a small horizontal distance (i.e., transversely away from pour spout 28) in three directions from opening 36. In a fourth direction, shell 30 may extend further due to a need to accommodate electronics housed therein.

When assembly 22 is inserted into and removed from opening 24 of container 20 (FIG. 1), pour spout 28 or shell 30 may be used as a lever to wiggle assembly 22 back-and-forth to assist in the insertion and removal processes. Such wiggling might otherwise impart significant mechanical stressing forces at the intersection of shell 30, pour spout 28, and sealing member 42. But in the preferred embodiment, stopping member 46 desirably has a somewhat larger diameter 46′ than at least some of sealing fins 58 to relieve the stresses at this intersection. In the preferred embodiment, diameter 46′ is around 24 mm to provide effective strain relief, and shell 30 extends less than 5 mm, and preferably only around 3 mm, beyond stopping member 46 in three directions transversely away from pour spout 28.

When a user wants to wash pour spout 28, pour spout 28 may be separated from sealing member 42 by pulling pour spout 28 and sealing member 42 apart from one another. At this point, a clean pour spout 28 may be reinserted into sealing member 42 by inserting pour spout 28 into the hollow opening in sealing member 42 while neck 64 of sealing member 42 is located within opening 36 of shell 30, and by pushing pour spout 28 and sealing member 42 together until stopping member 46 abuts shell 30. Pour spout assembly 22 may then remain in service, but with a clean, replacement pour spout 28, and the previous pour spout 28 can be cleaned in due course. Moreover, shell 30 and its internal components need not be subjected to the elevated heat and moisture of a typical washing process each time pour spout 28 is washed. But those skilled in the art will appreciate that nothing requires shell 30 and its internal components to avoid being washed, and that a preferred embodiment of pour spout assembly 22 discussed herein is sealed so that it too may be washed when needed.

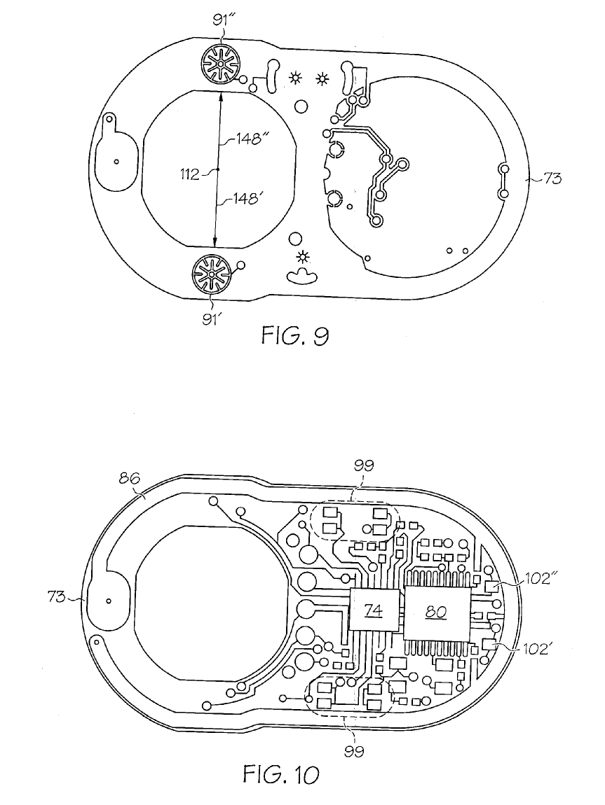

FIG. 8 shows a block diagram of an exemplary electronic circuit 72 housed within outer shell 30 of electronic pour spout assembly 22. FIG. 9 shows a bottom view of a printed wiring board (PWB) 73 with which the electronic circuit 72 may be formed, and FIG. 10 shows a top view of PWB 73.

Referring to FIGS. 8-10, circuit 72 includes a controller 74 which may be provided at least in part by a microprocessor, microcontroller, or other programmable device. Controller 74 couples to a clock 76, tilt sensor array 78, transmitter 80, and a memory 82. A battery 84 provides electrical power for controller 74 and may directly or indirectly provide power for any or all other components of circuit 72. Clock 76 provides a time base for circuit 72. Tilt sensor array 78 provides one or more tilt sensors which indicate when assembly 22 is in one or more predetermined tilted orientations relative to the force exerted by gravity.

In the embodiment of circuit 72 depicted in FIG. 8, circuit 72 uses transmitter 80 to transmit data to monitoring stations using a wireless, RF communication scheme. No receiver is included in circuit 72, so the communication scheme is unidirectional. This communication scheme provides advantages in accommodating a wide degree of freedom in the operation of an establishment and in keeping the operation of circuit 72 at a very low power level so that a small battery 84 may be used and not often replaced, if at all. Transmitter 80 couples to an antenna 86 and provides upconversion and amplification functions for the data communicated by circuit 72 and assembly 22. But those skilled in the art will appreciate that assembly 22 may alternately provide other types of electronic communication schemes, including bidirectional schemes, optical schemes, infrared schemes, inductive schemes, capacitive schemes, magnetic schemes, and schemes based on direct physical connection between contacts in assembly 22 and a device in data communication with assembly 22.

Memory 82 provides a variety of functions for circuit 72. For example, memory 82 provides computer programming instructions to be executed by controller 74 in a manner well known to those skilled in the art, along with various constants and memory space for variables, tables, and buffers used by controller 74 while executing the programming instructions.

Of course, those skilled in the art will appreciate that one or more of memory 82, clock 76, transmitter 80, and the like may be included on a common semiconductor substrate with controller 74.

Controller 74 also couples to a mount detector 88. Mount detector 88 indicates whether assembly 22 is mounted on a container 20 (FIG. 1). Mount detector 88 is configured as at least one, and preferably two, switches 90′ and 90″ arranged in a switch assembly. Switches 90 are coupled in parallel, with first nodes of both switches coupled to a low impedance path 92 controlled by controller 74 for power management purposes in the preferred embodiment. Second nodes of both switches 92 couple through a pull-up resistor 94 to a positive voltage and to an input of controller 74. In this embodiment, controller 74 occasionally tests to determine whether switches 90 are in open or closed states. Thus, controller 74 may, for power management purposes, cause low impedance path 92 to exhibit a low impedance, then sample the input from in-parallel switches 90 to controller 74. If either of switches 90 is in a closed state, then controller 74 declares a closed state for mount detector 88, indicating that assembly 22 is mounted on container 20. Only if both of switches 90 are in an open state does controller 74 declare an open state for mount detector 88, indicating that assembly 22 is not mounted on container 20. Of course, those skilled in the art will appreciate that mount detector 88 may be provided in a variety of other configurations which achieve substantially the same thing. For example, mount detector 88 may be configured to interrupt or wake-up controller 74 rather than be sampled by controller 74, and switches may be individually sampled by controller 74 with the above-discussed logic being performed in computer software. Switches 90 are formed, at least in part, through the use of conductive traces on PWB 73 configured to form a switch pattern 91 on PWB 73.

Controller 74 also couples to a user input section 96. User input section 96 is the portion of circuit 72 through which user input is provided to controller 74 and assembly 22. In this embodiment of circuit 72, user input section 96 is configured as at least one, and preferably two, switches 98′ and 98″. Unlike mount detector 88, in user input section 96 each switch 98 is treated independently of the other switch 98. Thus, first nodes of switches 98 couple to low impedance path 92, but second nodes of switches 98 respectively couple through individual pull-up resistors 94 to a positive voltage and to individual inputs of controller 74. As discussed above in connection with mount detector 88, a variety of alternate embodiments may achieve substantially the same thing in other ways. Switches 98 are formed, at least in part, through the use of conductive traces on PWB 73 configured to form a switch pattern 99 on PWB 73, in a manner that is discussed in more detail below.

Controller 74 also couples to a user feedback section 100. Through user feedback section 100 controller 74 and assembly 22 provide information to a user of assembly 22. This embodiment of user feedback section 100 includes at least one, and preferably two, light-emitting components 102′ and 102″. In this embodiment, light-emitting components 102 are provided by differently colored light-emitting diodes (LEDs), each of which has a cathode coupled to a positive voltage, and each of which has an anode coupled through a current-limiting resistor 104 to a respective output of controller 74. But those skilled in the art can devise a variety of alternate configurations for user feedback section 100 which accomplish substantially the same thing. Light-emitting components 102 are discussed in more detail below.

Battery 84 is one of the components of assembly 22 that exerts a significant influence on the size of assembly 22. Generally, battery-operated electronic circuits that consume greater amounts of power require either larger batteries or smaller batteries that must be replaced or recharged more often. Larger batteries require larger housings. Likewise, replaceable batteries tend to be placed in special battery compartments with associated hardware, located on an exterior wall of a larger housing. A special compartment with special location requirements and special hardware all make housings larger. And, reliance on battery replacement or recharging make the battery-operated electronic circuit less reliable because the likelihood increases that at any given instant the battery's charge state will be insufficient for the circuit's needs.

In the preferred embodiments of assembly 22, battery 84 is permanently positioned in shell 30. In other words, battery 84 is not intended to be user serviceable. And, circuit 72 is configured to take advantage of power-saving techniques. Examples of such techniques include omitting an RF receiver even though RF techniques are used to communicate data, using low power components, such as LEDs, arranging pull-up, pull-down, and current limiting resistors so they consume power only when necessary, operating controller 74 and transmitter 80 in stand-by or sleep modes for as long as possible, and the like. These and other power-saving techniques are desirably implemented in circuit 72 so that battery 84 need not be user serviceable but may nevertheless be as small as possible. Using such techniques and others known to those skilled in the art, battery 84 is desirably configured as a single, coin or button type of lithium battery with a smallest dimension 106 (FIG. 3) of its height at less than 8 mm.

Referring to FIG. 7, larger dimensions of battery 84 are described by a diameter 108 of battery 84. Opening 36 in shell 30 has a center 112, and battery 84 has a center 114. A battery direction 116 represents the direction in which shell 30 extends transversely away from pour spout 28, which resides in opening 36, to accommodate battery 84 and the other components of circuit 72. An anti-battery direction 117 represents the opposite direction from battery direction 116. Desirably, battery 84 is selected to exhibit a diameter-to-height ratio of greater than two. With such a battery, shell 30 need not extend a great distance in direction 116 transversely away from pour spout 28 to accommodate circuit 72. Due to the thinness of height 106 (FIG. 3) of battery 84, printed wiring board 73 on which some or all of circuit 72 is formed is positioned above battery 84 within shell 30 (FIG. 3), and the overall height of an assembled shell 30 is desirably less than 12 mm, and around 10 mm in preferred embodiment. In an application where circuit 72 uses a technique other than RF transmissions to report data back to a monitoring station, such as physical electrical contact, even lower-power results can be achieved for circuit 72 and even smaller batteries 84 can be used, with a corresponding further reduction in the size of shell 30.

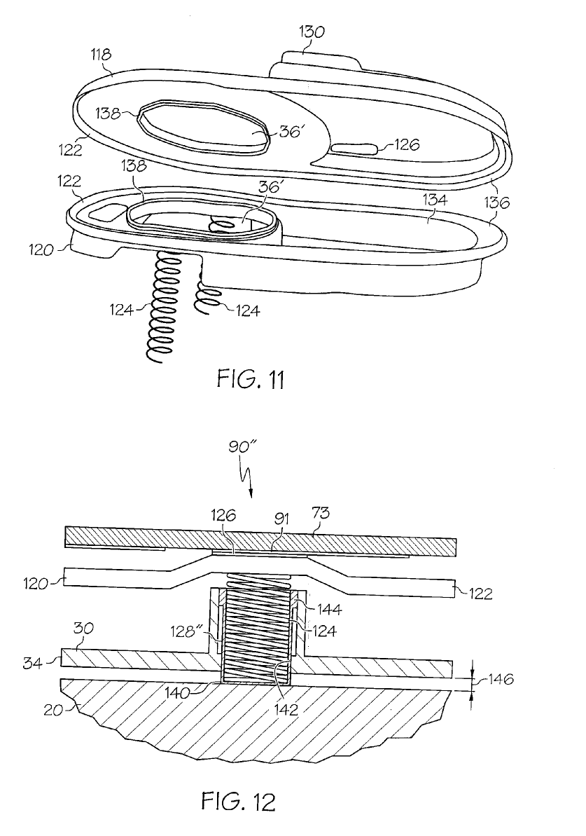

FIG. 11 shows an unassembled, perspective side view of top and bottom inner shell sections 118 and 120, respectively, which collectively form a resilient, substantially sealed, inner shell 122 that resides in outer shell 30 of electronic pour spout assembly 22. Top and bottom inner shell sections 118 and 120 of inner shell 122 are also depicted in FIG. 3, and bottom inner shell section 118 is also depicted in FIG. 7.

Referring primarily to FIGS. 3, 7, and 11, inner shell 122 is desirably molded from a non-opaque (i.e., clear or translucent) resilient, thermoplastic which remains flexible after molding. Inner shell 122 is desirably non-opaque so that it can accommodate the propagation of light, as discussed in more detail below.

Springs 124 attach to tabs on the bottom side of bottom inner shell 120 and extend downward. A conductive material 126, such as a conductive epoxy, is applied to the upper surface of bottom inner shell section 120, immediately opposite springs 124, and pressed against the bottom surface of PWB 73 (FIG. 9) to close mount-detector switches 90 (FIG. 8). Likewise, in this embodiment top inner shell 118 has upwardly-extending tabs 130 which extend through openings 132 (FIG. 5) in top outer shell 32 to form user-input switches 98 (FIG. 8). Conductive material 126 is applied to the inside (i.e., bottom) of top inner shell 118, opposite tabs 130 and pressed against the top surface of PWB 73 to close user-input switches 98. The resilience of the material from which top inner shell 118 is formed is used to urge tabs outward, against the pressing motion. Accordingly, inner shell sections 118 and 120 are made from a material with sufficient flexibility and resilience to accommodate repetitive flexure consistent with switch operation.

An interior region 134 of inner shell 122 holds circuit 72. Peripheral walls 136 surround peripheries of each of top and bottom inner shells 118 and 120. Peripheral wall 136 on top inner shell 118 extends toward bottom inner shell 120, and peripheral wall 136 on bottom inner shell 120 extends toward top inner shell 118. Inner shell 122 has a shell opening 36′ which corresponds in shape and alignment but is desirably slightly larger than shell opening 36 in outer shell 30 to accommodate shell-opening wall 38. Opening walls 138 surround shell opening 36′ in each of top and bottom inner shells 118 and 120. Opening wall 138 on top inner shell 118 extends toward bottom inner shell 120, and opening wall 138 on bottom inner shell 120 extends toward top inner shell 118.

On each of top and bottom inner shells 118 and 120, peripheral walls 136 and opening walls 138 have substantially the same shape and position so that peripheral walls 136 are pressed together during assembly and opening walls 138 are pressed together during assembly and form gaskets to substantially seal interior region 134 of inner shell 122. Accordingly, circuit 72 is at least water resistant, and preferably water proof, so that assembly 22 may be washed from time to time.

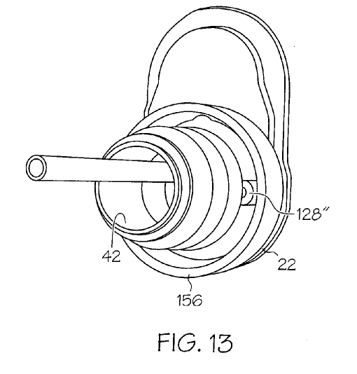

FIG. 12 shows a cross-sectional side view of one of mount detection switches 90 that may be formed using printed wiring board 73 and inner shell 122. Referring to FIGS. 1-3, 5, 9, and 12, springs 124 operate against and urge plungers 128 downward. Plungers 128, and particularly external ends 140 of plungers 128, extend through openings 142 in bottom outer shell 34, but are stopped from extending more than a predetermined distance downward by plunger rims 144 abutting bottom outer shell 34 at openings 142. When assembly 22 is not mounted on container 20, plungers 128 are fully extended. Switch patterns 91 are formed from two proximate, but electrically isolated, conductive paths, and nothing connects the two isolated paths. So, switches 90 are in their open states.

As assembly 22 is inserted into opening 24 of container 20, a portion of container 20 surrounding opening 24 contacts external ends 140 and pushes plungers 128 upward, retracting plungers 128. Desirably, PWB 73, inner shell 122, bottom outer shell 34, plungers 128, and springs 124 are mutually configured so that at a point before assembly 22 becomes fully seated on and abuts container 20, conductive material 126 on the inner surface of inner shell 122 contacts switch patterns 91 and causes switches 90 to close. In the preferred embodiment, this contact occurs when external end 140 of a plunger 128 is at a distance 146 of at least 2 mm away from the bottom surface of bottom outer shell 34. This distance enhances reliability by permitting assembly 22 to be installed on container 20 in a slightly canted orientation while still recognizing a mounted condition on container 20.

Moreover, the use of two mount-detection switches 90 connected so that the mounted condition is recognized when either switch 90 is closed but a dismounted condition is recognized only when both switches 90 are open, further enhances reliability. An even greater range for assembly 22 being canted on container 20 is still recognized as being the mounted condition because even if one of switches 90 is open due to a canted condition, the other switch 90 is likely to be closed.

The reliability of mount-detector 88 is further enhanced and the overall size of shell 30 is further compacted by the placement of switches 90 in the preferred embodiment of the present invention. In particular, referring to FIGS. 7 and 9, PWB 73 is configured to at least partially surround opening 36, so that switch patterns 91 on PWB 73 are aligned in a direction other than battery direction 116 or anti-battery direction 117. In the preferred embodiment, PWB 73 is permitted to entirely surround opening 36, but that is not a requirement. Greater reliability in the operation of mount detector 88 results from placing switches 90 as far apart as possible so that the likelihood of one switch 90 being pushed increases as the likelihood of the other switch 90 being pushed decreases due to canting. In the preferred embodiment, switches 90, including their switch patterns 91, are located on diametrically opposing sides of opening 36, aligned in switch directions 148′ and 148″ extending away from center 112 of opening 36. This places switch components, such as plungers 128, adjacent to sealing member 42, adjacent to shell opening 36, and adjacent to PWB 73.

Switch directions 148 are aligned in other than battery direction 116 or anti-battery direction 117, and are aligned roughly traverse to battery and anti-battery directions 116 and 117 in the preferred embodiment. This allows battery 84 to be positioned closer to opening 36 and shell 30 to extend transversely away from pour spout 128 a shorter distance. Consequently, the reliability of assembly 22 is enhanced while the size of assembly 22 is reduced.

Referring primarily to FIGS. 2, 3, 5, 8, and 10, as discussed above, circuit 72 includes light-emitting components 102. Circuit 72 is desirably configured to cause components 102 to emit light 150 from time to time. Light 150 is transmitted through and propagates in inner shell 122 because inner shell 122 is not opaque to the transmission of light. Outer shell 30 may be opaque to the transmission of light, but openings 152 are provided in top outer shell section 32 and aligned with components 102 so that light 150 may be readily viewed from outside shell 30 by a user facing roughly in tube-inlet direction 57 (i.e., from above assembly 22). Of course, those skilled in the art will appreciate that the viewing of light 150 includes the viewing of physical items, such as inner shell 122, illuminated by light 150.

In addition, openings 154 are provided in bottom outer shell section 34 close to, but not in line-of-sight of, components 102. Since light propagates in inner shell 122, inner shell 122 conducts light 150 to openings 154 where it may be viewed from outside shell 30 by a user to the side of and/or facing roughly in tube-outlet direction 53 (i.e., from below assembly 22). Accordingly, light-emitting components 102 are PWB-mounted for reduced size and ease of assembly, and light 150 emitted therefrom is nevertheless visible on a plurality of sides of assembly 22 because of the non-opaque properties of inner shell 122 and of the placement of openings 152 and 154 in outer shell 30. Enhanced viewing range is provided without increasing the size of assembly 22.

Of course, those skilled in the art will appreciate that alternate embodiments can also result in having light 150 visible from opposing sides of assembly 22. For example, outer shell 30 may be formed from a transparent or translucent material and/or lights 102 may be mounted outside of outer shell 30. These and other equivalent alternatives are to be included within the scope of the present invention.

FIG. 13 shows a perspective view of electronic pour spout 22 that depicts a tamper shield 156 installed thereon. Tamper shield 156 is desirably a clear, hard plastic ring that permanently attaches, when installed, to the bottom side of bottom outer shell 34 at a position that causes it to surround sealing member 42 and plungers 128. In addition, tamper shield 156 has a sufficient inner diameter so that it easily fits over the opening in typical bottles that may serve as containers 20 (FIG. 1). Tamper shield 156 also has a sufficient inner diameter so that plungers 128 can freely extend and retract. Tamper shield 156 is provided to impede tampering with plungers 128 in a manner that might falsely indicate a mounted condition when assembly is actually dismounted. Desirably, tamper shield 156 is a clear color for aesthetic reasons so that assembly 22 appears to be as small as possible.

In summary, the present invention provides an improved compact electronic pour spout assembly. The compact electronic pour spout assembly provides a space-saving way to attach a pour spout, sealer, and electronics housing to one another. The pour spout may be easily separated from the sealer and electronics housing so that the pour spout may be washed. The compact electronic pour spout assembly provides a space-saving and reliable way to signify that the assembly is installed in a container. And, the compact electronic pour spout assembly is compatible with the use of a supple cork.

Although preferred embodiments of the invention have been illustrated and described in detail, it will be readily apparent to those skilled in the art that various modifications may be made therein without departing from the spirit of the invention or from the scope of the appended claims. For example, those skilled in the art will appreciate that further compactness may be achieved in the electronic pour spout assembly described herein by extending the teaching provided above. For example, user-input switches or other components may be omitted altogether, and one or more smaller batteries may be used. In addition, those skilled in the art will appreciate that other modifications may be included which have little or no increasing impact on size, such as including an even greater number of mount detection switches. These and other changes and modifications are intended to be included in the scope of the present invention.

1. A compact electronic pour spout assembly (22) comprising:
a pour spout (28) having a blocking member (46) and a rigid pour tube (44), said pour tube having an inlet end (50) and an outlet end (52), and said pour tube being attached to said blocking member between said inlet and outlet ends;
a hollow, resilient, sealing member (42) having a neck (64) with an outer wall (68) and an inner wall (70), said inner wall being configured to accommodate said pour tube; and
a rigid shell (30) housing an electronic circuit (72), said shell having an opening (36) shaped to conform to said outer wall of said neck of said sealing member, wherein said shell, said sealing member, and said pour spout are locked to one another by resilient pressing of said sealing member against said rigid pour tube and said rigid shell.

2. A compact electronic pour spout assembly as claimed in claim 1 wherein:
said outer wall of said neck exhibits a first diameter (64′);
said sealing member additionally comprises a plurality of annular sealing fins (58) each having at least a second diameter (58′); and
said first diameter is less than said second diameter.

3. A compact electronic pour spout assembly as claimed in claim 2 wherein:
said blocking member is a rigid annular stopping member which abuts said shell and through which said pour tube passes, said stopping member exhibiting a third diameter (46′) greater than or equal to said second diameter.

4. A compact electronic pour spout assembly as claimed in claim 1 wherein:
said opening in said shell has a first shape; and
said sealing member additionally comprises a shoulder (66) having a second shape configured so that when said neck of said sealing member is inserted into said opening in said shell, said shoulder abuts a surface of said shell.

5. A compact electronic pour spout assembly as claimed in claim 1 wherein:
said outer wall of said neck of said sealing member has a nonround cross-sectional shape; and
said opening in said shell substantially exhibits said nonround cross-sectional shape so that said sealing member does not rotate relative to said shell.

6. A compact electronic pour spout assembly as claimed in claim 1 wherein:
said inner wall of said neck of said sealing member has a nonround cross-sectional shape; and
said pour tube portion of said pour spout substantially exhibits said nonround cross-sectional shape so that said sealing member does not rotate relative to said pour tube.

7. A compact electronic pour spout assembly as claimed in claim 6 wherein:
said pour spout additionally comprises a vent tube (48) positioned adjacent said pour tube and extending on opposing sides of said blocking member; and
said nonround cross-sectional shape of said inner wall of said neck of said sealing member accommodates said vent tube and said pour tube.

8. A compact electronic pour spout assembly as claimed in claim 1 wherein:
said shell extends transversely away from said pour spout in a first direction (116); and
an electronic circuit includes a switch (90) with a plunger (128) extending outside said shell, said switch residing alongside said neck of said sealing member in a second direction (148′) transverse to said first direction.

9. A compact electronic pour spout assembly as claimed in claim 8 wherein:
said electronic pour spout is configured to be installed in an opening (24) of a container (20) by inserting said sealing member in said container opening until said container abuts said shell;
said plunger has an external end (140) that is spring-biased to extend away from said shell;
said switch is configured to be in a first state when said external end of said plunger is fully extended away from said shell and to achieve a second state when said external end of said plunger is a distance (146) of at least 2 mm away from said shell.

10. A compact electronic pour spout assembly as claimed in claim 8 wherein:
said switch (90) is a first switch (90′) and said plunger (128) is a first plunger (128′); and
said electronic circuit includes a second switch (90″) with a second plunger (128″) extending outside said shell, said second switch residing alongside said neck of said sealing member in a third direction (148″) transverse to said first direction and substantially opposite to said second direction.

11. A compact electronic pour spout assembly as claimed in claim 10 wherein:
said first switch and said second switch are coupled in parallel to form a switch assembly (88);
said switch assembly is in a first state when external ends of both of said first and second plungers are fully extended away from said shell; and
said switch assembly is in a second state when either of said first and second switches is fully retracted toward said shell.

12. A compact electronic pour spout assembly as claimed in claim 8 additionally comprising an tamper shield (156) surrounding said neck of said sealing member and said plunger.

13. A compact electronic pour spout assembly as claimed in claim 1 wherein said electronic circuit comprises no more than a single battery (84), said single battery having a diameter to height ratio of greater than 2.0.

14. A compact electronic pour spout assembly as claimed in claim 1 wherein said electronic circuit comprises a battery having a smallest dimension (106) of less than 8 mm.

15. A compact electronic pour spout assembly as claimed in claim 1 wherein said electronic circuit comprises a nonreplaceable battery permanently positioned within said shell.

16. A compact electronic pour spout assembly as claimed in claim 1 wherein:
said electronic circuit is configured to emit a light (150);
said light is visible from outside said shell in a first direction (53) which faces said outlet end of said pour tube; and
said light is visible from outside said shell in a second direction (57) which opposes said first direction.

17. A compact electronic pour spout assembly as claimed in claim 16 wherein said electronic circuit comprises:
a printed wiring board (73) positioned within said shell; and
a light-emitting component (102) mounted on one side of said printed wiring board.

18. A compact electronic pour spout assembly as claimed in claim 1 wherein:
said rigid shell is an outer shell; and
said assembly additionally comprises a resilient, substantially sealed, inner shell (122), wherein said electronic circuit is positioned within said inner shell, and said inner shell is positioned within said outer shell.

19. A compact electronic pour spout assembly as claimed in claim 18 wherein:
said outer shell comprises a top section (32) and a bottom section (34), wherein said top section is permanently attached to said bottom section; and
said inner shell comprises a top section (118) and a bottom section (120), wherein a first one of said top and bottom inner shell sections has a peripheral wall (136) extending toward a second one of said top and bottom inner shell sections, and said peripheral wall is pressed into sealing engagement with said second one of said top and bottom inner shell sections by said permanent attachment of said top and bottom outer shell sections.

20. A compact electronic pour spout assembly as claimed in claim 18 wherein:
said outer shell comprises a top section and a bottom section, wherein said top section is permanently attached to said bottom section; and
said inner shell comprises a top section and a bottom section, wherein each of said top and bottom sections has an opening (36′) aligned with said opening in said outer shell, a first one of said top and bottom inner shell sections has an opening wall (138) extending toward a second one of said top and bottom inner shell sections, and said opening wall is pressed into sealing engagement with said second one of said top and bottom inner shell sections by said permanent attachment of said top and bottom outer shell sections.

21. A compact electronic pour spout assembly as claimed in claim 18 wherein said inner shell is not opaque to the transmission of light.

22. A compact electronic pour spout assembly as claimed in claim 18 wherein:
said electronic circuit comprises a printed wiring board having conductive traces configured to form a switch pattern (91, 99) thereon; and
an inner surface of said inner shell is coated with a conductive material (126) in alignment with said switch pattern so that a switch portion of said electronic circuit closes when said inner shell is pressed against said switch pattern.

23. A compact electronic pour spout assembly as claimed in claim 22 wherein:
said inner shell is configured to have an outward projecting tab (130) which extends through an opening (132) in said outer shell; and
said switch pattern is aligned with said outward projecting tab.

24. A compact electronic pour spout assembly (22) comprising:
a shell (30) having an opening (36) surrounding an opening center (112);
an electronic circuit (72) positioned within said shell, said electronic circuit having a printed wiring board (73) surrounding at least a portion of said shell opening and having a battery (84) with a center point (114) spaced away from said opening center in a battery direction (116);
a pour spout (28) extending away from a first side of said shell at said shell opening;
a sealing member (42) extending away from a second side of said shell at said shell opening, said second side opposing said first side; and
a plunger (128) extending away from said second side of said shell, adjacent to said sealing member, adjacent to said shell opening, adjacent to said printed wiring board, and aligned in a direction (148) other than said battery direction and other than the opposite of said battery direction away from said opening center.

25. A compact electronic pour spout assembly as claimed in claim 24 wherein:
said electronic pour spout is configured to be installed in an opening (24) of a container (20) by inserting said sealing member in said container opening until said container abuts said shell;
said plunger has an external end (140) that is spring-biased to extend away from said second side of said shell;
said plunger cooperates with said printed wiring board to form a switch (90) configured to be in an open state when said external end of said plunger is fully extended away from said shell and to achieve a closed state when said external end of said plunger is a distance (146) of at least 2 mm away from said shell.

26. A compact electronic pour spout assembly as claimed in claim 24 wherein:
said plunger (128) is a first plunger (128′) and said first plunger is aligned in a first-plunger direction (148′) away from said opening center; and
said electronic pour spout assembly additionally comprises a second plunger (128″) extending away from said second side of said shell, adjacent to said sealing member, adjacent to said shell opening, adjacent to said printed wiring board, and aligned in a second-plunger direction (148″) away from said opening center, said second-plunger direction being different than said battery direction, said direction opposite of said battery direction, and said first-plunger direction.

27. A compact electronic pour spout assembly as claimed in claim 26 wherein:
said first and second plungers cooperate with said printed wiring board to form first and second switches, respectively;
said first switch and said second switch are coupled in parallel to form a switch assembly (88);
said switch assembly is in a first state when external ends of both of said first and second plungers are fully extended away from said shell; and
said switch assembly is in a second state when either of said first and second switches is fully retracted toward said shell.

28. A compact electronic pour spout assembly as claimed in claim 24 additionally comprising a tamper shield (156) surrounding a portion of said sealing member and said plunger.

29. A compact electronic pour spout assembly as claimed in claim 24 wherein said battery has a smallest dimension (106) of less than 8 mm.

30. A compact electronic pour spout assembly as claimed in claim 24 wherein:
said shell is a rigid outer shell; and
said assembly additionally comprises a resilient, substantially sealed, inner shell (122), wherein said electronic circuit is positioned within said inner shell, and said inner shell is positioned within said outer shell.

31. A compact electronic pour spout assembly as claimed in claim 30 wherein:
said printed wiring board has conductive traces configured to form a switch pattern (91) thereon; and
an inner surface of said inner shell is coated with a conductive material (126) in alignment with said switch pattern so that a switch portion of said electronic circuit closes when said plunger presses said inner shell against said switch pattern.

32. A compact electronic pour spout assembly as claimed in claim 24 wherein:
said electronic circuit is configured to emit a light (150);
said light is visible from outside of said first side of said shell; and
said light is visible from outside of said second side of said shell.

33. A compact electronic pour spout assembly (22) comprising:
a shell (30) having an shell opening (36);
an electronic circuit (72) positioned within said shell, said electronic circuit being configured to emit a light (150);
a pour spout (28) extending away from a first side of said shell at said shell opening; and
a sealing member (42) extending away from a second side of said shell at said shell opening, said second side opposing said first side, wherein said light is visible from outside said first and second sides of said shell.

34. A compact electronic pour spout assembly as claimed in claim 33 wherein said electronic circuit comprises:
a printed wiring board (73) positioned within said shell; and
a light-emitting component (102) mounted on one side of said printed wiring board.

35. A compact electronic pour spout assembly as claimed in claim 33 wherein:
said shell is a rigid outer shell; and
said assembly additionally comprises a resilient, substantially sealed, inner shell (122), wherein said electronic circuit is positioned within said inner shell, and said inner shell is positioned within said outer shell.

36. A compact electronic pour spout assembly as claimed in claim 35 wherein said inner shell is not opaque to the transmission of visible light.

37. A compact electronic pour spout assembly as claimed in claim 35 wherein said electronic circuit comprises:
a printed wiring board positioned within said inner shell; and
a light-emitting component mounted within said inner shell on one side of said printed wiring board.

38. A compact electronic pour spout assembly as claimed in claim 37 wherein:
said inner shell is not opaque to the transmission of visible light;
said outer shell is substantially opaque to the transmission of visible light;
said outer shell has a first opening (152) on said first side of said shell through which light propagating within said inner shell is visible; and
said outer shell has a second opening (154) on said second side of said outer shell through which light propagating within said inner shell is visible.
